(19) United States
(12) Patent Application Publication
(10) Pub. No.: US 2012/0239239 A1
(43) Pub. Date: Sep. 20, 2012

(54) VEHICLE

(75) Inventor: Norihiko SUYAMA, Inuyama-shi (JP)

(73) Assignee: MURATA MACHINERY, LTD., Kyoto-shi (JP)

(21) Appl. No.: 13/414,977

(22) Filed: Mar. 8, 2012

(30) Foreign Application Priority Data
Mar. 17, 2011 (JP) 2011-059171

(51) Int. Cl. G05D 1/00

(52) U.S. Cl. 701/25

(57) ABSTRACT

A vehicle automatically drives along a driving course having objects located around the vehicle. The vehicle includes a vehicle main body, a distance measurement sensor, a map data recording unit, an approximate line calculation unit, and a position and attitude calculating unit. The distance measurement sensor is provided in the vehicle main body, and measures distances to objects located around the vehicle. The map data recording unit stores map data recording objects located around the vehicle in the driving course. The approximate line calculation unit calculates approximate lines, based on a set of position data obtained with a one-time scanning of the distance measurement sensor. The position and attitude calculating unit performs a matching check between the approximate lines and the map data, thereby calculating the position and attitude of the vehicle main body.

### BACKGROUND OF THE INVENTION

1. Field of the Invention

The present invention relates to vehicles, particularly to vehicles that automatically drive along a driving course around which objects are located.

2. Description of the Related Art

Conventionally, vehicles that automatically drive along a driving course around which objects are located have been developed. The vehicle is equipped, for example, with a distance measurement sensor, an environment map memory, and a controller.

The distance measurement sensor scans a laser beam around a forward range of 270 degrees, for example, and receives a reflected light from obstacles. Based on the reflected light received from the obstacles, the position data of the reflector is obtained. The environment map memory stores an environment map that indicates areas where objects located around the vehicle exist in a moving space and areas where objects located around the vehicle do not exist in the moving space. The controller compares the position data of the reflector and the environment map in order to calculate the position and attitude of the vehicle. Accordingly, the controller can obtain the position and attitude of the vehicle, as disclosed in Japanese Patent Laid-Open Publication 2010-86416.

Conventionally, the position data of the reflector and the environment map consist of pixel data. In other words, the controller performs a matching process (calculation of position and attitude) using pixels. Accordingly, the required storage capacity has been increased for storing the environment map, so that it is necessary to prepare a large-capacity recording medium. In addition, the processing time for attitude calculation tends to increase, and a high performance CPU is required.

### SUMMARY OF THE INVENTION

Preferred embodiments of the present invention provide a vehicle that obtains position and attitude of the vehicle with less calculation required.

A vehicle according to a preferred embodiment of the present invention is a vehicle that automatically drives along a driving course having objects located around the vehicle. The vehicle includes a vehicle main body, a distance measurement sensor, a map data recording unit, an approximate line calculation unit, and a position and attitude calculating unit. The distance measurement sensor is provided in the vehicle main body, and measures distances to objects located around the vehicle. The map data recording unit stores map data recording objects located around the vehicle in the driving course. The approximate line calculation unit calculates approximate lines, based on a set of position data obtained with a one-time scanning of the distance measurement sensor. The position and attitude calculating unit performs a matching check between the approximate lines and the map data, thereby calculating the position and attitude of the vehicle main body.

According to the vehicle, the approximate line calculation unit calculates approximate lines based on the set of position data obtained with a one-time scanning of the distance measurement sensor. Then, the position and attitude calculating unit performs a matching check between the approximate lines and the map data, thereby calculating the position and attitude of the vehicle main body. Accordingly, unlike the prior art, pixel data is not used to perform matching, so that the amount of data to be processed can be decreased. As a result, it is possible to obtain the position and attitude of the vehicle with less calculation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic perspective view of a vehicle and driving course according to a preferred embodiment of the present invention.

FIG. 2 is a schematic plain view of a vehicle and driving course.

FIG. 3 is a diagram of the position data and the approximate lines.

FIG. 4 is a view of approximate lines obtained from the position data.

FIG. 5 is a view of a portion of map data.

FIG. 6 is a view of line segments constituting a portion of the map data.

FIG. 7 is a block diagram showing the control configuration of the vehicle.

FIG. 8 is a flow chart of the overall scan control.

FIG. 9 is a flow chart of the approximate line generation control.

FIG. 10 is a flow chart of the association control.

FIG. 11 is a flow chart of the calculation control on position and attitude.

FIG. 12 is a view of association using approximate lines that has already been associated.

FIG. 13 is a view of position and attitude calculation using the approximate lines and the line segment information of the map data.

### DETAILED DESCRIPTION OF THE PREFERRED EMBODIMENTS

Referring mainly to FIG. 1 to FIG. 6, a first preferred embodiment of the present invention will be generally explained.

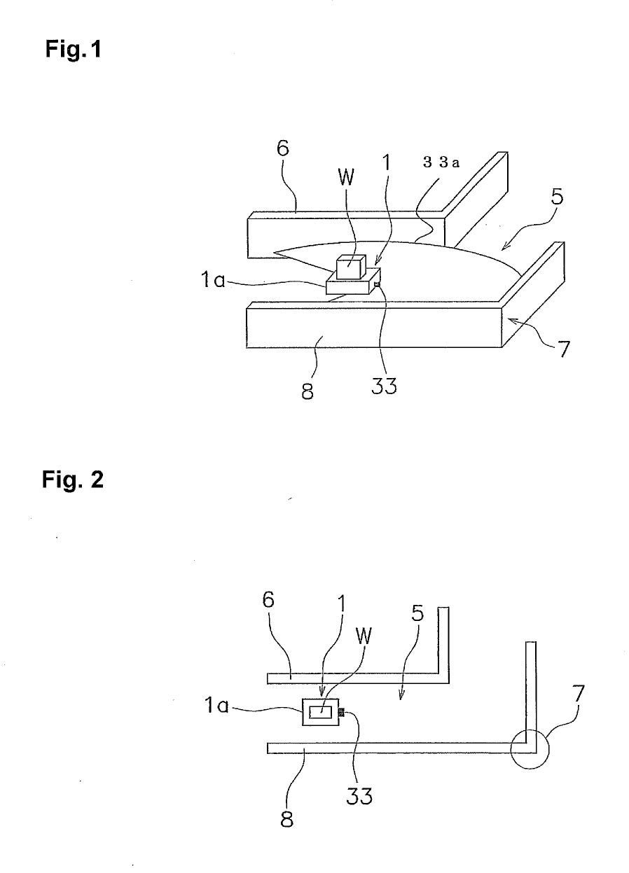

As shown in FIG. 1 and FIG. 2, a vehicle 1 drives with an article W placed thereon. The vehicle 1 drives along a driving course 5. The driving course 5 is defined between a first wall 6 and a second wall 8. The first wall 6 and the second wall 8 function as obstacles for the vehicle 1.

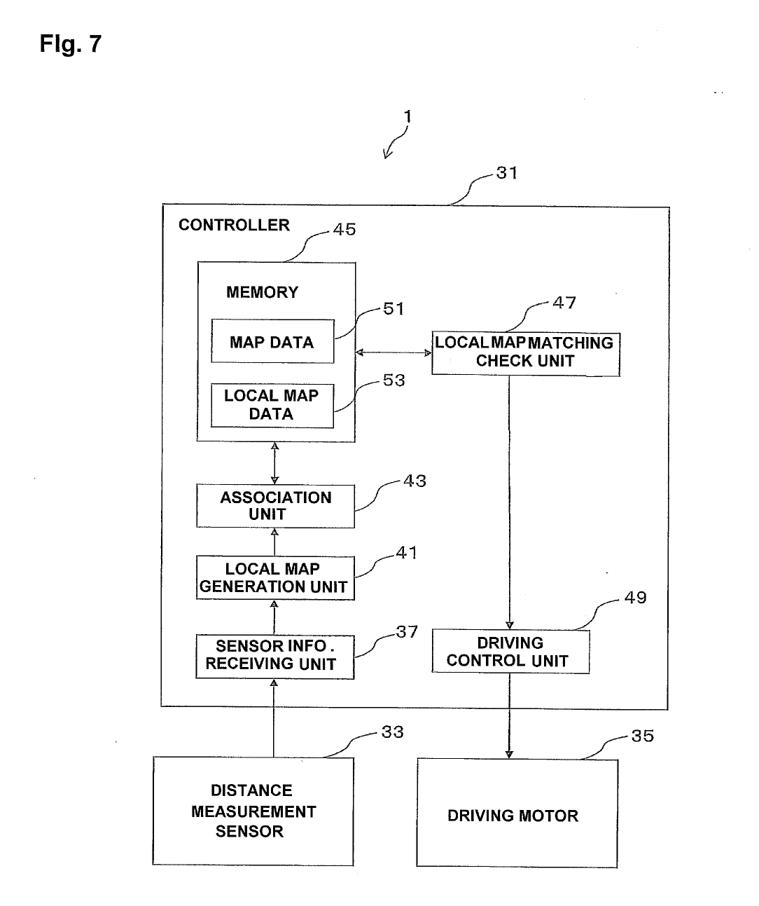

The vehicle 1 preferably includes a vehicle main body 1a, a distance measurement sensor 33, and a controller 31 (refer to FIG. 7).

The vehicle main body 1a includes a driving motor 35 (refer to FIG. 7), and driving wheels (not shown).

The distance measurement sensor 33 is a sensor arranged to detect obstacles on the front in a driving direction of the vehicle 1. The distance measurement sensor 33 may be a laser range finder, including a laser emitter emitting laser pulse signals to a target and a laser receiver receiving the laser pulse signals reflected from the target. Then, the distance measurement sensor 33 calculates the distance based on the reflected laser pulse signals. The distance measurement sensor 33 can spread the laser beam in a fan-shaped configuration, spanning around 270 degrees in a horizontal direction on the front of the vehicle main body 1a, by reflecting the emitted laser beam against a rotating mirror. FIG. 1 shows an irradiation area 33a of the laser. The scan cycle of the laser range finder is about 25 milliseconds to about 100 milliseconds, for example. The position data of the reflector can be obtained based on the measuring results of the distance measurement sensor 33.

In FIG. 1 and FIG. 2, the first wall 6 and the second wall 8, which constitute the driving course 5, are located on both sides of the vehicle 1, and include a corner on the front in the driving direction of the vehicle 1. In the corner of the driving course 5, the second wall 8 includes a corner portion 7.

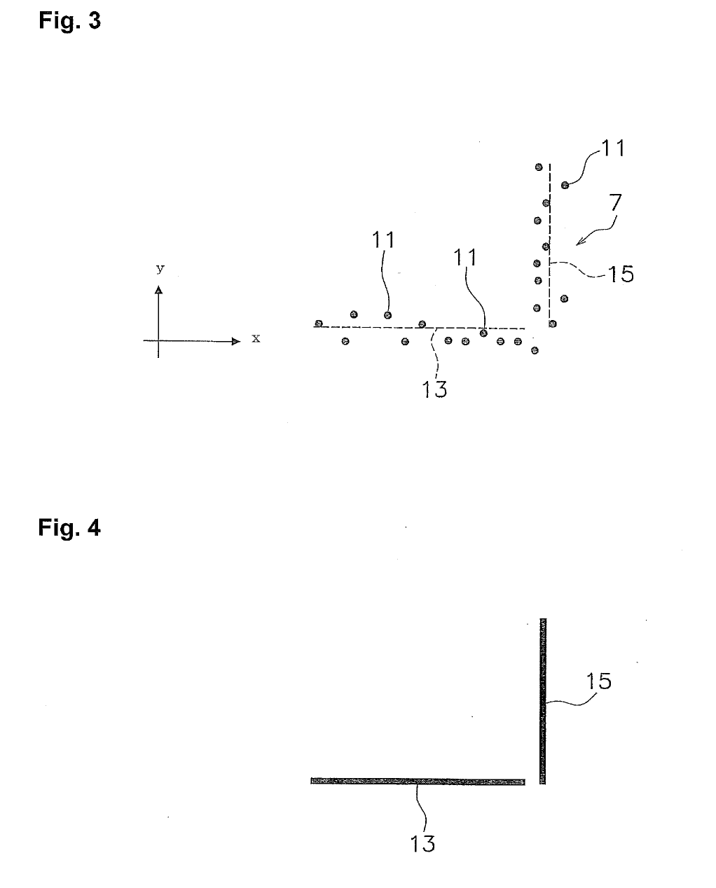

FIG. 3 shows measuring results on the corner portion 7 obtained by the distance measurement sensor 33. As shown in FIG. 3, regarding the corner portion 7, a plurality of measuring points 11 (i.e., calculated position data) have been obtained. Based on the measuring points 11, as shown in FIG. 3 and FIG. 4, a first approximate line 13 and a second approximate line 15 are obtained. More specifically, a plurality of measuring points 11 are divided into two sets in which straight lines are likely to be constituted by the measuring points, and a straight line is generated corresponding to each set. For example, a plurality of measuring points 11 are divided into a set whose measuring points 11 are positioned within a predetermined distance in the x direction, and a set whose measuring points 11 are positioned within a predetermined distance in the y direction. Then, the approximate line of each set is calculated. In addition, it is also acceptable to estimate a straight line which has the shortest distance from a plurality of measuring points, and to calculate the approximate lines by dividing the plurality of measuring points into a plurality of sets based on differences in slope. The calculation method of the approximate lines is not limited.

In this preferred embodiment, the first approximate line 13 and the second approximate line 15 preferably are straight, for example. However, the approximate lines may be curve lines.

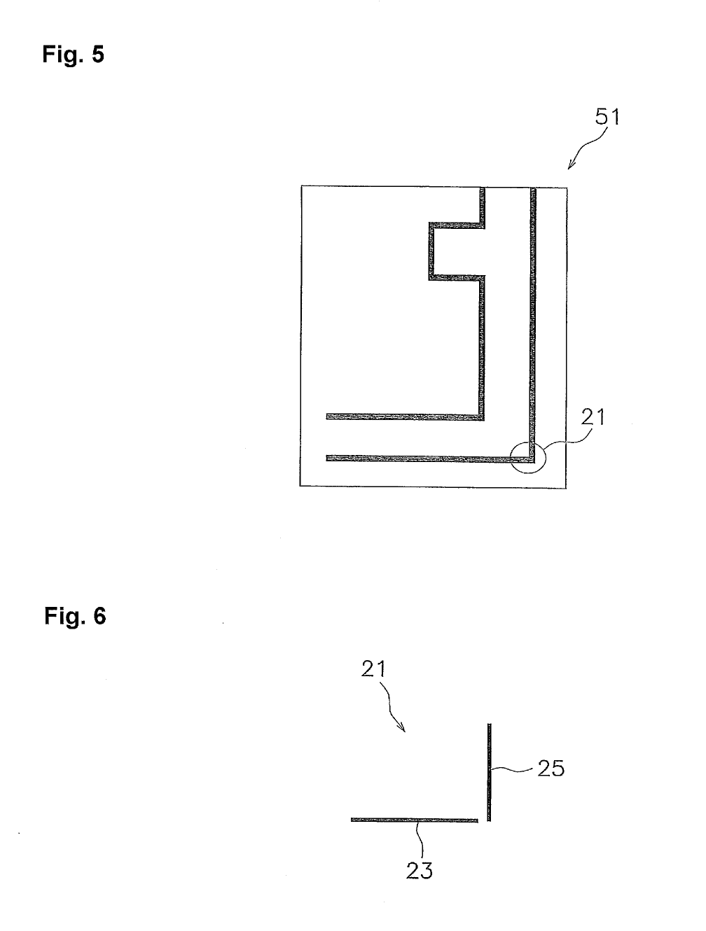

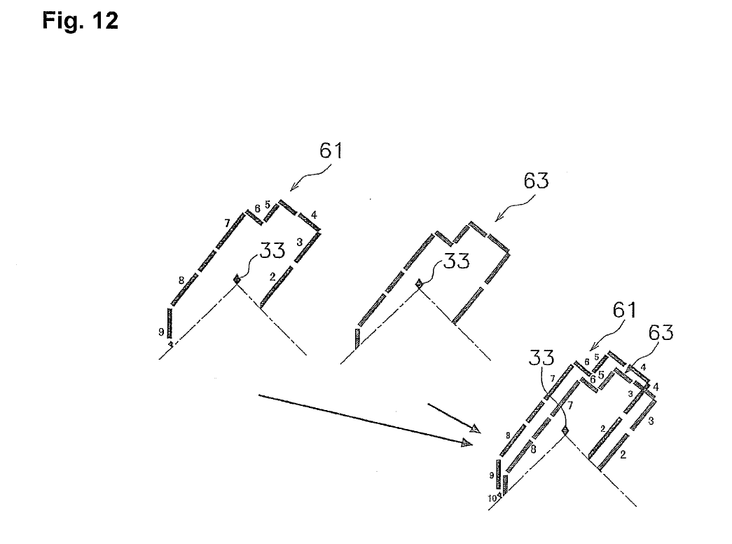

FIG. 5 and FIG. 6 show map data 51 held by the vehicle 1. The map data 51 is constituted by a plurality of line segment information indicating an outline of the driving course 5. An exclusive number is assigned to each line segment, like approximate lines (later described) in FIG. 12. In other words, the outline of the driving course 5 shown in FIG. 5 and FIG. 6 is divided into a plurality of line segments, and a number is assigned to each line segment, thereby constituting the line segment information.

The map data 51 includes first line segment information 23 and second line segment information 25 for a corner portion 21.

If an association is to be performed to show that the first approximate line 13 corresponds to the first line segment information 23 and the second approximate line 15 corresponds to the second line segment information 25, position estimation is performed by matching. The matching involves calculating relative position and attitude between the two data so as to have the geometric characteristics of both data (corner portions, for example) overlapped. Accordingly, the position (e.g., coordinate) and attitude (i.e., angle) of the vehicle 1 are obtained (described in detail later). In this preferred embodiment, it is acceptable that the first approximate line 13 and the first line segment information 23 do not completely correspond to each other, and the second approximate line 15 and the second line segment information 25 do not completely correspond to each other.

As described above, the corner potions defined by two approximate lines are used as geometric characteristic portions of both of the data when the association between the approximate lines and the map data is performed. Accordingly, it is easy and accurate to perform the association between the two data.

As described above, according to the vehicle 1, based on a set of position data obtained with a one-time scanning by the distance measurement sensor 33, the approximate lines are calculated. Then, the vehicle 1 performs a matching check between the approximate lines and the map data, thereby calculating the position and attitude of the vehicle main body 1a. Unlike the prior art, without using pixel data to perform the matching check, the amount of data to be processed is decreased. As a result, it is possible to obtain the position and attitude of the vehicle 1 with less calculation.

Referring to FIG. 7 to FIG. 13, another preferred embodiment will be explained in detail.

FIG. 7 is a block diagram showing the control configuration of the vehicle. The vehicle 1 includes a controller 31. The controller 31 may be a computer including a CPU, RAM, and ROM, and executes programs so as to perform a driving control.

The configuration and function of the controller 31 will be explained. The controller 31 includes a sensor information receiving unit 37, a local map generation unit 41, an association unit 43, a memory 45, a local map matching check unit 47, and a driving control unit 49. The sensor information receiving unit 37 has the function of receiving position data from the distance measurement sensor 33. The local map generation unit 41 performs the function of calculating approximate lines based a plurality of position data. The association unit 43 performs the function of associating the approximate lines with the line segments of the map data 51 (later described in detail), and storing the associated approximate lines into the memory 45 as local map data. The memory 45 stores the map data 51 and local map data 53.

The local map matching check unit 47 performs a matching check between the local map data with line segment information of the map data 51, thereby calculating position and attitude of the vehicle main body 1a.

The driving control unit 49 sends driving instructions to the driving motor 35, based on a given driving instruction, current position and attitude.

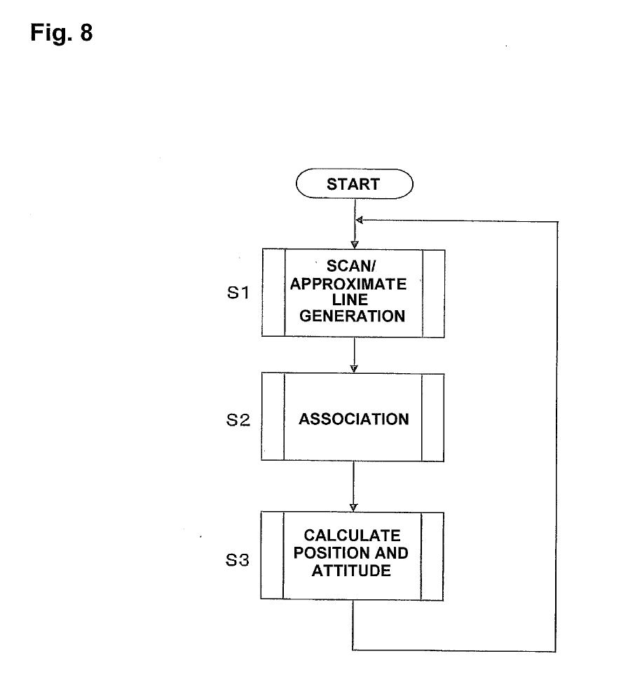

Referring to FIG. 8, explanation is provided of operations of the vehicle 1 to obtain position and attitude of the vehicle 1. In Step S1, scan/approximate line generation is performed. At this time, a plurality of position data is obtained and at least one approximate line is generated. In Step S2, the generated approximate lines are associated with the line segment information of the map data 51. In Step S3, the associated approximate lines and line segment information of the map data 51 are overlapped with each other, thereby calculating the position and attitude of the vehicle main body 1a.

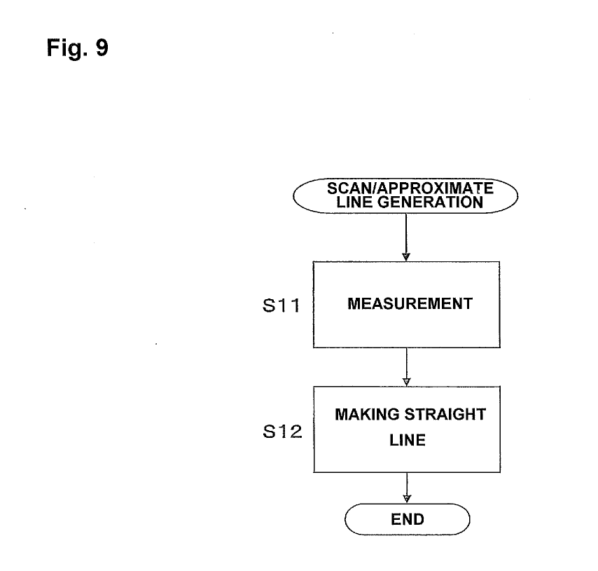

Referring to FIG. 9, Step S1 of FIG. 8 will be explained in detail.

In Step S11, the distance measurement sensor 33 performs scanning to obtain the position data. Subsequently, the sensor information receiving unit 37 receives a set of the position data (position information of a plurality of measuring points obtained with a one-time scanning of the distance measurement sensor 33) from the distance measurement sensor 33, and sends the position data to the local map generation unit 41.

In Step S12, the local map generation unit 41 generates, based on the position information of the plurality of measuring points, at least one approximate line (refer to FIG. 3 and FIG. 4.). The local map generation unit 41 sends a local map including a plurality of approximate lines to the association unit 43.

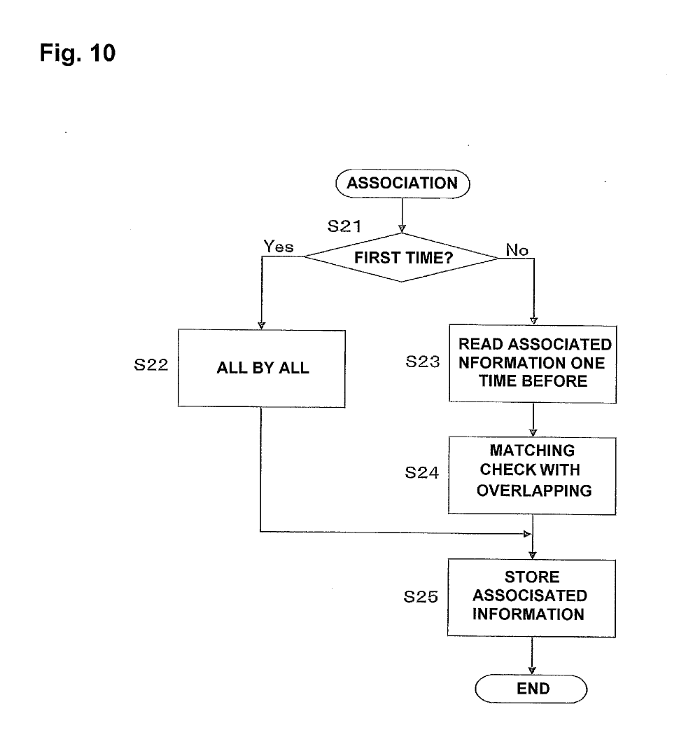

Referring to FIG. 10, Step S2 of FIG. 8 will be explained in detail.

In Step S21, the association unit 43 determines whether an association is the first one or not. If the determination is “Yes”, the process moves on to Step S22, and if the determination is “No”, the process moves on to Step S23.

In Step S22, the association unit 43 searches for line segment information of the map data 51 corresponding to the approximate lines with all-play-all (round robin algorithm). For example, the association unit 43 compares the approximate lines with line segment information of the map data 51 with all-play-all, and associates the approximate lines with the line segment information. The association is performed such that the approximate lines match the line segment information or the difference between the approximate lines and the line segment information becomes small, for example. In order to realize the association, the association unit 43 assigns the number of each line segment of the line segment information of the associated map data 51 to the approximate lines. The association unit 43 stores the associated approximate lines into the memory 45 as the local map data 53. The local map data 53 includes the position data and the number of each line segment of the approximate lines, for example.

In addition, in Step S23, the association unit 43 reads out the local map data 53 (approximate lines) obtained from the scanning one time before, from the memory 45. The read out local map data 53 have already been associated with the map data 51.

In Step S24, the association unit 43 performs a matching check between the already associated approximate lines and the approximate line that is newly generated, thereby associating the newly generated approximate line with the line segments of the map data 51. FIG. 12 shows such an example. FIG. 12 shows a set 61 of the already associated approximate lines, and a set 63 of the approximate lines that have been newly generated. It should be noticed that in this case, as apparent from the figure, the vehicle 1 drives within a closed space surrounded by walls, and the approximate lines correspond to the surfaces of the walls. The numbers 2 through 9 shown in the set 61 of the already associated approximate lines are the numbers of the line segments of the corresponding map data 51.

The association unit 43 overlaps and performs a matching check between the set 61 of the already associated approximate lines and the set 63 of the approximate lines that have been newly generated. Then, the association unit 43 assigns each of the approximate lines of the set 63 of the approximate lines that have been newly generated with the number of the line segments of the corresponding map data 51. It should be noted that for the above-described overlapping, moving distance and moving angle of the distance measurement sensor 33, i.e., moving distance and moving angle of the vehicle 1, are taken into account. More specifically, moving amount and orientation of the distance measurement sensor 33 between the previous two times and the previous one time are considered. For example, the association unit 43 shifts the set 61 of the already associated approximate lines by the moving amount and orientation of the distance measurement sensor 33. The association unit 43 matches the set 61 of the approximate lines, after they have been shifted, with the set 63 of the approximate lines which are newly generated. Then, the association unit 43 assigns the number of the corresponding line segments of the set 61 to the set 63 of the approximate lines which are newly generated.

As described above, the association unit 43 associates the approximate lines with the line segment information based on the approximate lines with which the line segments have been already associated. Hence, the calculation amount used to associate the approximate lines with the line segment information decreases. Accordingly, the processing speed is improved. Particularly, since the association is performed with the movement amount of the vehicle taken into account, the association between the approximate lines and the line segment information becomes more accurate.

In Step S25, the association unit 43 stores the set of the newly associated approximate lines into the memory 45 as the local map data 53.

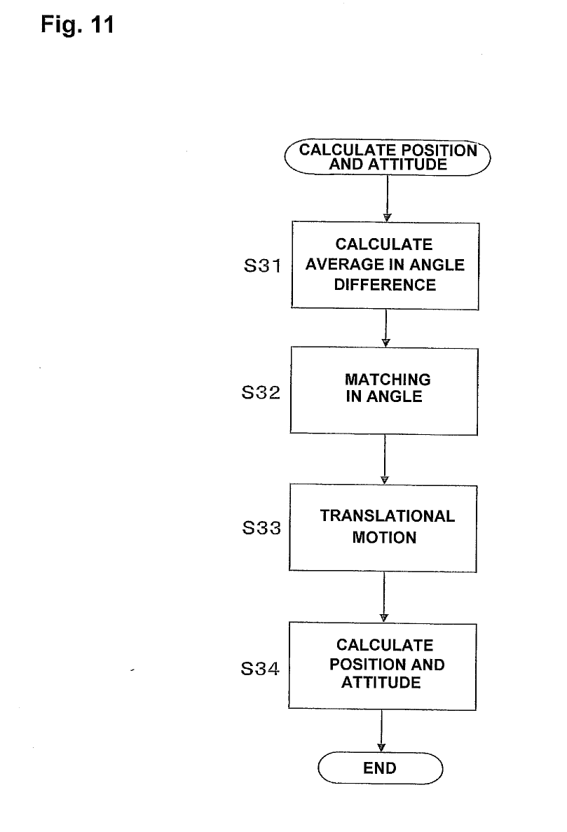

Referring to FIG. 11, Step S3 of FIG. 8 will be explained in detail.

In Step S31, the local map matching check unit 47 calculates the average angle difference between the line segments of the newly associated approximate lines and the segment information associated therewith. For example, the local map matching check unit 47 calculates the angle difference between each line segment of the approximate line which is newly associated and line segments of the map data 51 corresponding thereto, and then determines the average value.

In Step S32, the local map matching check unit 47 rotates the line segments of the newly associated approximate lines, depending on the average angle difference, thereby matching them with the angle of the line segment information associated therewith. In other words, the orientation of the distance measurement sensor 33 is matched with the orientation of the map data 51.

In Step S33, the local map matching check unit 47 moves the line segments of the newly associated approximate lines translationally, thereby matching them with the line segment information associated therewith. The translational movement amount is determined in a way that the longitudinal translational movement amount is determined by comparing specific line segments with each other, and then the lateral direction movement amount is determined by comparing specific line segments with each other. As a result, the calculation amount is decreased.

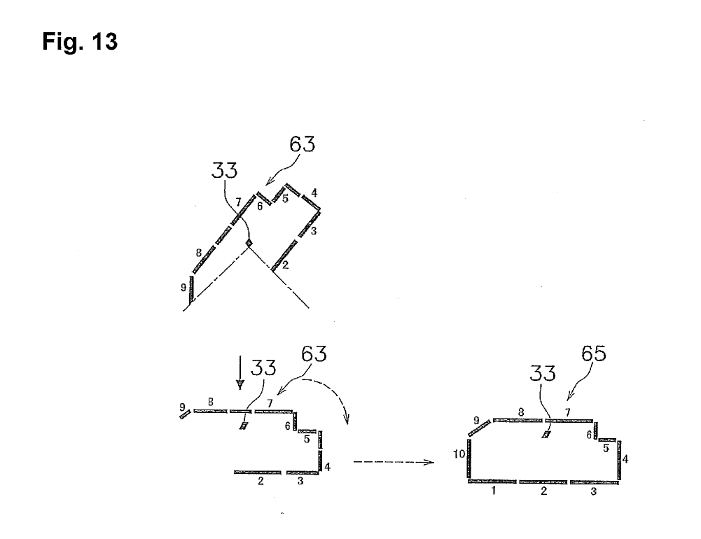

FIG. 13 shows an example of the above-described explanation. In FIG. 13, a set 63 of the already associated approximate lines and the line segment information 65 of the map data 51 are shown. In Step S32, the set 63 of the associated approximate lines are rotated. In Step S33, the set 63 of the associated approximate lines are moved translationally, and are overlapped with the line segments of the corresponding map data 51. In Step S34, the local map matching check unit 47 calculates the position and attitude of the vehicle main body 1 in the map data 51 based on the rotational angle and translational movement amount.

In the vehicle 1, the local map generation unit 41 calculates the approximate lines based on a set of position data obtained with a one-time scanning of the distance measurement sensor. Next, the local map matching check unit 47 performs a matching check between the calculated approximate lines and the map data, thereby calculating position and attitude of the vehicle main body 1a. As described above, unlike the prior art, since the pixel data is not used for matching, the amount of data to be processed is decreased. Accordingly, it is possible to obtain position and attitude of the vehicle with less calculation.

In addition, the local map matching check unit 47 performs a matching check between the approximate lines and the line segment information only based on the combination of the rotational movement and the translational movement. Accordingly, the matching check can be performed with a decreased calculation load.

The present invention is not limited to the preferred embodiments described above. Various changes can be made without departing from the scope of the present invention. In particular, various features, characteristics and steps of the preferred embodiments and variations described above can be combined freely as necessary or desired.

Although in the above-described preferred embodiments, in order to measure distances to the objects located around the vehicle, the laser range finder is preferably used, other sensors may be used.

Although in the above-described preferred embodiments, during association, the approximate line which is newly generated is preferably associated with the map data by using the approximate lines with which the line segment of the map data has already been associated, it may be directly associated with the line segment information of the map data.

According to the above-described preferred embodiments, in order to determine the translational movement amount of the approximate lines which have been associated, the specific line segments are preferably compared with each other. However, variance of all combinations of line segments to be compared with each other may be used as the translational movement amount. In this case, deviation and variability decrease.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vehicle for driving along a driving course having objects located around the vehicle, the vehicle comprising;
a vehicle main body;
a distance measurement sensor provided in the vehicle main body, and configured to measure distances to the objects located around the vehicle multiple times;
a map data recording unit configured to store map data including data of the objects located around the vehicle along the driving course;
an approximate line calculation unit configured to calculate approximate lines based on a set of position data obtained by performing a one-time scanning of the distance measurement sensor; and
a position and attitude calculating unit configured to perform a matching check between the approximate lines and the map data to calculate a position and an attitude of the vehicle main body.

2. The vehicle according to claim 1, wherein the map data recording unit stores the data of the objects located around the vehicle as a plurality of line segment information, and the position and attitude calculating unit performs the matching check between the approximate lines and the line segment information only based on a combination of rotational movement and translational movement.

3. The vehicle according to claim 2, further comprising an association unit configured to associate the approximate lines with the line segment information, wherein the association unit associates the approximate lines calculated based on the one-time scanning of the distance measurement sensor with the line segment information, based on the approximate lines already associated with the line segment information.

4. The vehicle according to claim 3, wherein the association unit takes into account a moving distance of the vehicle main body when associating the approximate lines calculated based on the one-time scanning of the distance measurement sensor with the line segment information.

5. The vehicle according to claim 3, wherein the association unit associates the approximate lines with the line segment information of the map data during a first association, and associates approximate lines calculated based on the one-time scanning of the distance measurement sensor with the line segment information, based on the approximate lines already associated with the line segment information, during a second or subsequent association.

6. The vehicle according to claim 5, wherein the approximate lines include a first approximate line and a second approximate line obtained along the driving course having a direction different from a driving direction of the vehicle main body, and the association unit associates the approximate lines with the map data based on a corner portion defined by the first approximate line and the second approximate line.
